(19) United States
(12) Patent Application Publication
(10) Pub. No.: US 2016/0057738 A1
(43) Pub. Date: Feb. 25, 2016

(54) METHOD FOR MONITORING PAGING OCCASIONS IN A WIRELESS COMMUNICATION SYSTEM AND DEVICE THEREFOR

(71) Applicant: LG ELECTRONICS INC., Seoul (KR)

(72) Inventors: Sunyoung LEE, Seoul (KR); Seungjune YI, Seoul (KR); Youngdae LEE, Seoul (KR); Sungjun PARK, Seoul (KR)

(73) Assignee: LG ELECTRONICS INC., Seoul (KR)

(21) Appl. No.: 14/784,541

(22) PCT Filed: Apr. 24, 2014
(86) PCT No.: PCT/KR2014/003589

§ 371 Date: Oct. 14, 2015

Related U.S. Application Data
(60) Provisional application No. 61/821,662, filed on May 9, 2013.

(51) Int. Cl. H04W 72/04; H04W 76/04; H04W 68/00

(52) U.S. Cl. CPC H04W 72/042; H04W 68/005; H04W 76/048

(57) ABSTRACT

The present invention relates to a wireless communication system. More specifically, the present invention relates to a method and a device for monitoring paging occasions in the wireless communication system, the method comprising: receiving paging information and an indicator for selecting paging occasions (POs) to be used for the UE; calculating one or more first POs in a paging frame based on the paging information; and monitoring one or more second POs among the one or more first POs based on the indicator.

### TECHNICAL FIELD

The present invention relates to a wireless communication system and, more particularly, to a method for monitoring paging occasions and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE

### Technical Problem

An object of the present invention devised to solve the problem lies in a method and device for monitoring paging occasions in a wireless communication system. The technical problems solved by the present invention are not limited to the above technical problems and those skilled in the art may understand other technical problems from the following description.

### Technical Solution

The object of the present invention can be achieved by providing a method for operating by an user equipment (UE) in wireless communication system, the method comprising; receiving paging information and an indicator for selecting paging occasions (POs) to be used for the UE; calculating one or more first POs in a paging frame based on the paging information; and monitoring one or more second POs among the one or more first POs based on the indicator.

In another aspect of the present invention, a method for a base station (BS) operating in a wireless communication system, the method comprising: transmitting paging information and an indicator for selecting paging occasions (POs) to be used for a user equipment (UE); and transmitting one or more Physical Downlink Control Channel (PDCCH) signals for the one or more second POs, wherein the one or more second POs are selected among one or more first POs in a paging frame based on the indicator

In another aspect of the present invention, provided herein is a UE (User Equipment) in the wireless communication system, the UE comprising: an RF (radio frequency) module; and a processor configured to control the RF module, wherein the processor is configured to receive paging information and an indicator for selecting paging occasions (POs) to be used for the UE, and to calculate one or more first POs in a paging frame based on the paging information, and to monitor one or more second POs among the one or more first POs based on the indicator.

Preferably, the one or more second POs are in the paging frame.

Preferably, said monitoring comprises monitoring one or more Physical Downlink Control Channel (PDCCH) signals for the one or more second POs.

Preferably, the paging information is related to DRX parameters used for deriving the paging frame and the one or more first POs.

Preferably, the paging information and the indicator are received through an RRC signaling.

Preferably, the indicator indicates at least one of: n^{th} second PO among the one or more first POs; 1^{st} to n^{th} second POs among the one or more first POs; nₓ^{th}, n_{y}^{th}, and n_{z}^{th} second POs (where x, y, . . . , z are consecutive) among the one or more first POs; nₓ^{th}, n_{y}^{th}, and n_{z}^{th} second POs (where x, y, . . . , z are not consecutive) among the one or more first POs; or one or more second POs among the one or more first POs according to a specific pattern.

Preferably, one or more third POs among the one or more first POs are not monitored based on the indicator, wherein the one or more third POs are different from the one or more second POs.

It is to be understood that both the foregoing general description and the following detailed description of the present invention are exemplary and explanatory and are intended to provide further explanation of the invention as claimed.

### Advantageous Effects

According to the present invention, monitoring paging occasions can be efficiently performed in a wireless communication system. Specifically, when the UE receives an indicator for selecting paging occasions to be used for the UE, the UE can monitor the paging occasions efficiently based on the indicator.

It will be appreciated by persons skilled in the art that that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4 is a diagram of an example physical channel structure used in an E-UMTS system;

FIG. 5 is a diagram showing an exemplary transmission of paging channel used in the E-UMTS system;

FIG. 6 is a diagram showing an exemplary a paging occasion in a paging frame used in the E-UTMS system;

FIG. 7 is a diagram showing an exemplary multiple paging occasions in the Long-DRX operation;

FIG. 8 is a diagram showing a method for a Long-DRX operation in the LTE system;

FIG. 9 is a conceptual diagram for monitoring paging occasions according to embodiments of the present invention;

FIG. 10 is a conceptual diagram an exemplary paging occasions according to embodiments of the present invention; and

FIG. 11 is a block diagram of a communication apparatus according to an embodiment of the present invention.

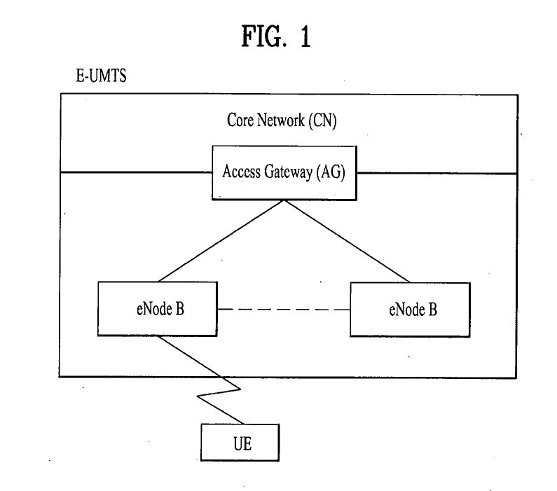

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

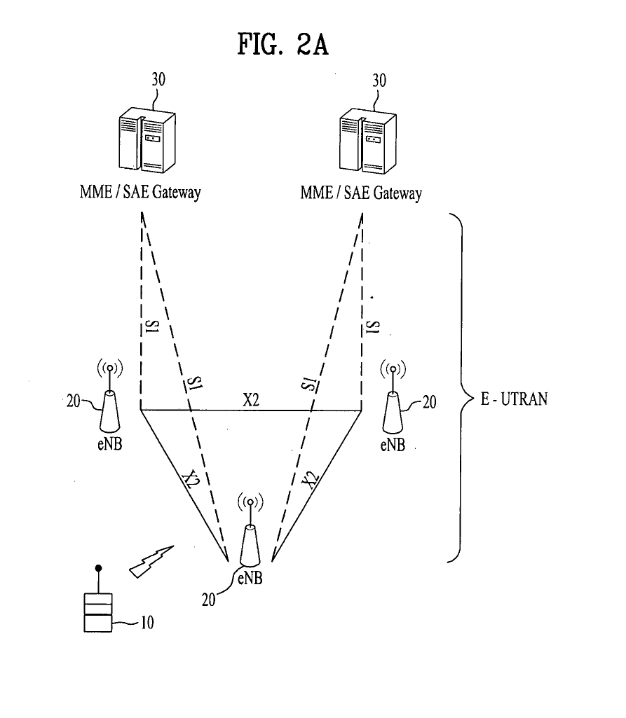

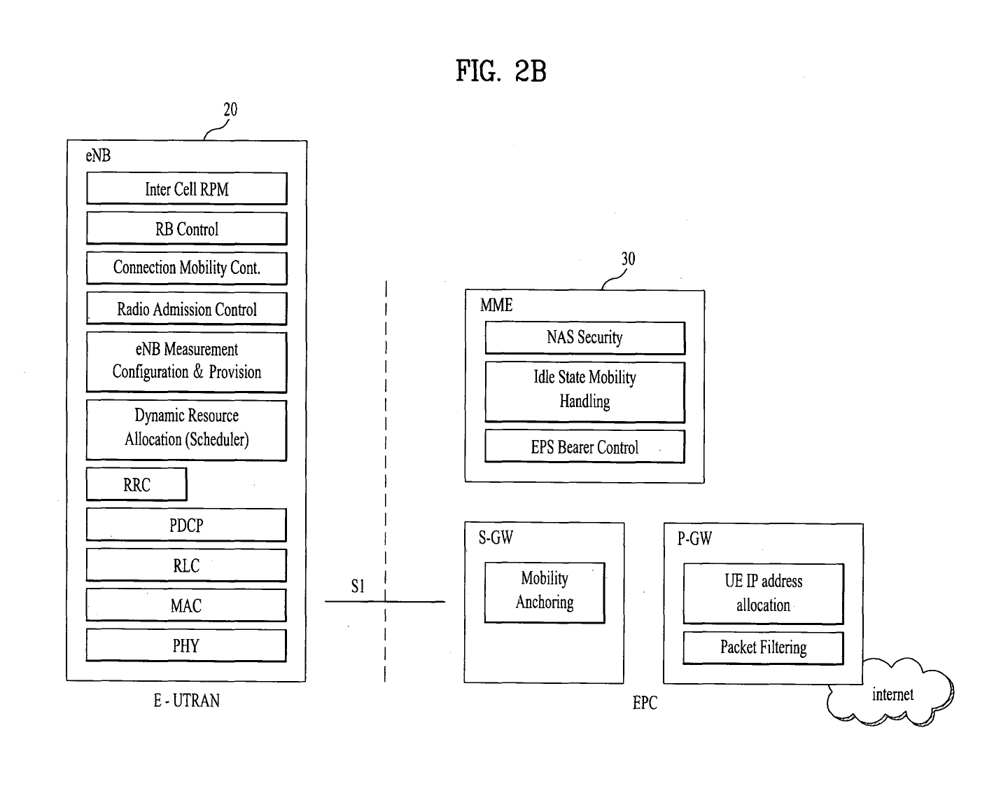

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

FIG. 2B is a block diagram depicting architecture of a typical E-UTRAN and a typical EPC. As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

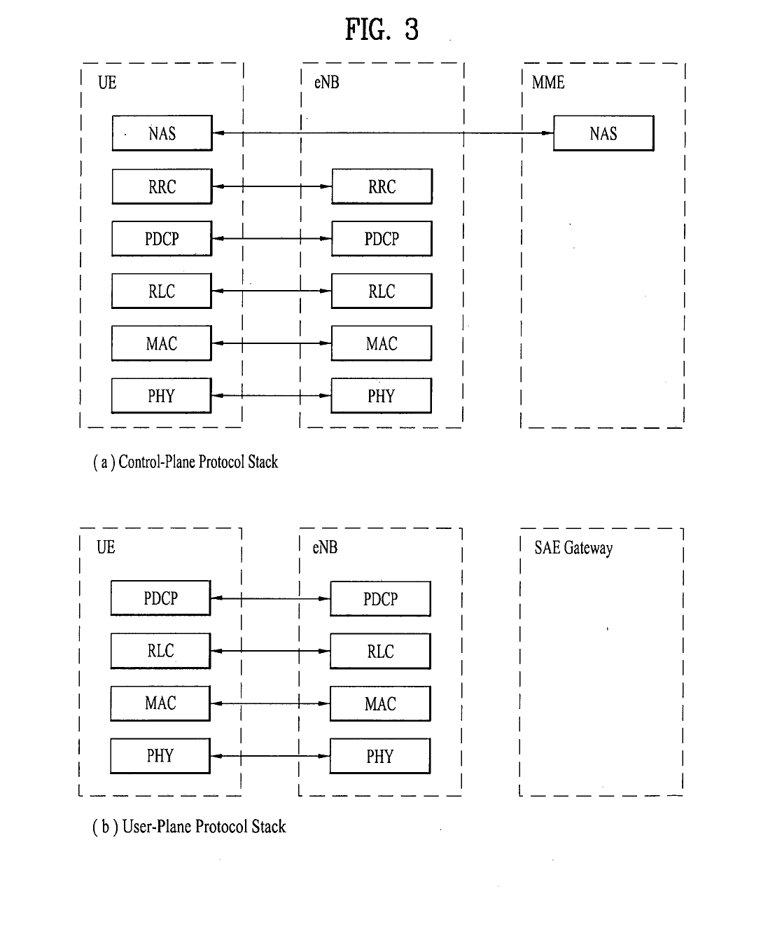

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

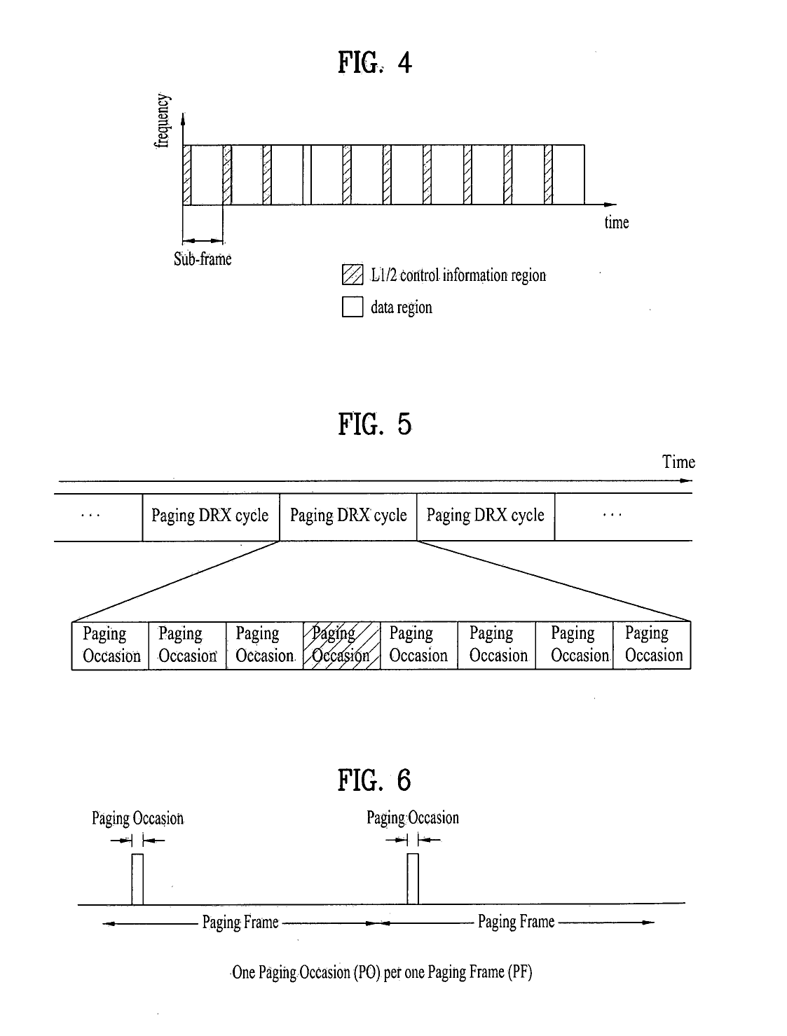

FIG. 4 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 4, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

FIG. 5 illustrates an exemplary transmission of paging channel used in the E-UMTS system and FIG. 6 is a diagram showing an exemplary a paging occasion in a paging frame used in the E-UTMS system. When receiving a paging message, a User Equipment (UE) can perform Discontinuous Reception (DRX) in order to reduce power consumption. To accomplish this, the network constructs a number of paging occasions in each period of time, which is referred to as a “paging DRX cycle”, and allows a specific UE to receive a specific paging occasion to obtain a paging message. The UE does not monitor paging channel at any time other than the specific paging occasion. One paging occasion corresponds to one TTI. The UE receives a downlink channel every, specified paging occasion. Specifically, at each paging occasion, the UE awakes to monitor a PDCCH signal. When the UE receives a Paging-RNTI (P-RNTI) corresponding to paging through the PDCCH, the UE receives a radio resource indicated by the PDCCH. One Paging Frame (PF) is one Radio Frame, which may contain one or multiple Paging Occasions. When DRX is used the UE needs only to monitor one PO per DRX cycle. An actual paging message is transmitted through the radio resource. The UE receives the paging message and checks whether or not an identifier is identical to an identifier of the UE (i.e., an identifier such as an International Mobile Subscriber Identity (IMSI) allocated to the UE) is present in the paging” message. When an identical identifier is present, the UE transfer the paging message to an upper layer.

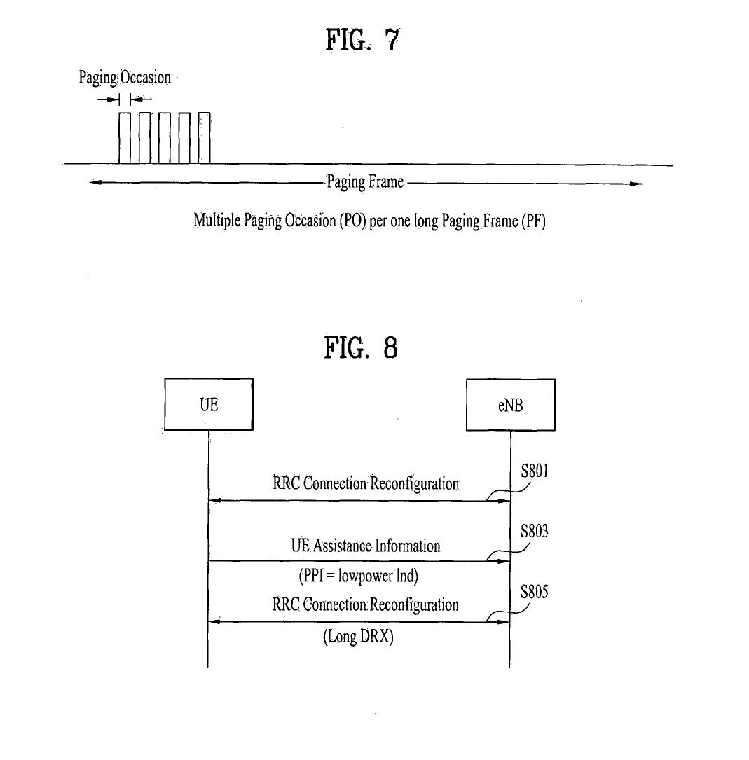

FIG. 7 is a diagram showing an exemplary multiple paging occasions in the Long-DRX operation.

Regarding FIG. 7, when the UE is configured a long (or extended) DRX operation, there may be multiple paging occasions in the one paging frame. In order to achieve “UE Power Consumption Optimizations”, the characteristics of solution may be that the Maximum DRX cycles in idle mode are possibly extended with longer values allowing the UE to save battery as waking up and listening for a potential paging message is one major power consuming functionality. When this solution is used, paging transmission period is also adjusted based on the extended DRX cycle applied to the UE.

Extended DRX cycles are enabled in UTRAN/E-UTRAN by providing the parameters for extended DRX in NAS (Non-Access Stratum). The current DRX parameters from UE to network are extended in a backward compatible way to ensure that normal UEs, i.e. UEs not requiring low power consumption, are not impacted. For enabling the extended DRX cycle in UTRAN/E-UTRAN, UE and network should exchange their support for the extended DRX (either by an explicit capability indication or implicitly when requesting the extended DRX cycle value). In this procedure, the availability of extended DRX for the UE should be decided in consideration of the UE's capability, the network condition (e.g., ISR activation), as well as the support of extended DRX of the RAN (Radio Access Network) nodes within an area served by the core network node. This is because the UE can travel through several RAN nodes without performing location update, even when some part of RAN nodes do not support the extended DRX (e.g., legacy E-UTRAN nodes in TA or legacy UTRAN nodes in the ISR activated case). The support of extended DRX of the RAN nodes could be informed to the MME by using S1/Iu signaling, OA&M method, or manual configuration. If supported, the UE can request the configuration use of the extended DRX cycle at any time, by using a NAS procedure.

For E-UTRAN, the MME needs to indicate eNB to adopt the UE specific DRX value in the paging message rather than the shortest one of the UE specific DRX value and a default DRX value broadcast in system information. After UE reports the extended DRX value in the NAS, the UE also ignores the default value broadcasted in the system information and adopt the reported one. In GERAN (GSM/EDGE RAN) longer paging transmission periods are enabled by in extending the parameter “BS-PA-MFRMS”. The extension could be done e.g. by multiplying the BS-PA-MFRMS parameter with a given value used as a paging multiplier factor. This factor should then be communicated between UE and CN (Core network) and then from CN to GERAN e.g. by adding the multiplier, factor to the paging message.

Paging timers and paging repetition in MSC/SGSN/MME are accommodated to cater for the extended DRX cycle. In addition, network could notify that the UE should alternate the extended DRX cycle (value specified in the NAS parameter for extended DRX) with one or several normal DRX cycle(s) (value of the DRX parameter multiplied by “1”). Such notification could be sent to the UE in a NAS message e.g. the Attach Accept/TAU Accept.

Paging re-transmission timers in the MSC/SGSN/MME should be adapted to fit in the needs of the extended DRX cycle and normal DRX cycle. The used DRX value needs to be known by the UE, RAN and MME/SGSN.

FIG. 8 is a diagram showing a method for a Long-DRX operation in the LTE system.

When the eNB wants the UE to be configured as the Long-DRX operation, the eNB sends RRC connection reconfiguration message to UE by enabling the power preference indicator (S801). This allows UE to be able to perform power preference indication procedure.

The UE decides to enter low power consumption mode. It sends the sends UE Assistance Information message to eNB with power preference indicator set to low power consumption (S803). The decision for UE initiating low power consumption mode may be based on the UE configuration by the network or UE implementation.

The eNB on receiving the UE assistance information provides UE with long DRX cycle in RRC Connection reconfiguration (S805). In RRC connection reconfiguration message there is ‘MAC config IE’ which includes the ‘DRX config IE’ which can be adjusted. Currently maximum value defined for DRX cycle length is 2.56 second. The eNB may assign maximum or higher DRX cycle to UE. Higher value of DRX cycle beyond 2.56 may be defined. Higher value of DRX cycle beyond 2.56 second requires analysis by 3GPP RAN WGs.

In the RRC layer, the DRX mechanism is used for power saving for the UE in RRC_IDLE. In the RRC_IDLE mode DRX operation, the UE only monitors one Paging Occasion (PO) per the one Paging Frame (PF), as presented. If the PF is set to be very long for some reasons, e.g., several hours/days/months of PF for the MTC devices, and if the UE monitors only one time of PO during such a long PF, it could happen that the UE may miss PDCCH addressing the paging message. Thus, it seems like that for some cases, the UE in RRC_IDLE may be configured with multiple POs during one PF, as presented in FIG. 7 to increase the chances that the UE successfully receives the paging message in IDLE mode.

However, there could be a case that the paging message for a UE is scheduled during specific POs. Conventionally, in the case that there could be multiple POs within one PF, there is no way that the UE selects at least one specific POs among multiple POs and monitors PDCCH in the selected POs during one PF.

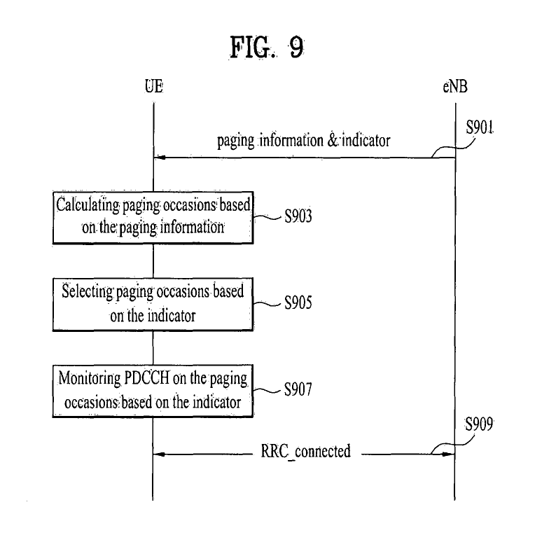

FIG. 9 is a conceptual diagram for monitoring paging occasions according to embodiments of the present invention.

In this invention, it is proposed that the UE may select at least one specific PO(s) among multiple PO candidates within one PF, and monitor PDCCH in the one or more selected POs during the PO.

The UE may receive paging information and an indicator for selecting paging occasions (POs) to be used for the UE from the eNB (S901). The paging information may be related to a DRX parameter transmitted by a RRC signaling.

The DRX parameter may be used for deriving the paging frame and the multiple paging occasion candidates. The DRX parameter may include ‘T’, ‘nB’, ‘N’, ‘Ns’ or ‘UE_ID’, etc.

‘T’ indicates DRX cycle of the UE. ‘T’ is determined by the shortest of the UE specific DRX value, if allocated by upper layers, and a default DRX value broadcast in system information. If UE specific DRX is not configured by upper layers, the default value is applied. ‘nB’ represents 4T, 2T, T, T/2, T/4, T/8, T/16 and T/32. ‘N’ represents minimum value between ‘T’ and ‘nB’. Ns represents maximum value between ‘1’ and ‘nB/T’. And ‘UE_ID’ represents ‘IMSI’ mod ‘1024’. The IMSI is given as sequence of digits of type Integer (0 . . . 9), IMSI may in the formulae above interpreted as a decimal integer number, where the first digit given in the sequence represents the highest order digit.

The UE calculates the PF and the PO candidates based on the DRX parameter (S903). The PF is given by following Equation A:

SFN mod T=(T div N)*(UE_ID)mod N [Equation A]

Here, the SFN represents system frame number, and index i_s pointing to PO candidates from subframe pattern will be derived from following Equation B:

i_{—}s=flooring(UE_ID/N)mod Ns [Equation B]

System Information DRX parameters stored in the UE may be updated locally in the UE whenever the DRX parameter values are changed in SI. If the UE has no IMSI, for instance when making an emergency call without USIM, the UE shall use as default identity UE_ID=0 in the PF and i_s formulas above.

After the step of S903, the UE may select one or more specific POs among the one or more PO candidates based on the indicator (S905). The indicator may include a set of indicators indicating whether the PO candidates are specific POs to be monitored by the UE.

The indicator may indicate a specific PO as n^{th} specific PO among the one or more PO candidates. The indicator may indicate specific POs as 1^{st} to n^{th} specific POs among the one or more PO candidates. Or, the indicator may indicate specific POs as nₓ^{th}, n_{y}^{th}, and n_{z}^{th} specific POs (where x, y, . . . , z are consecutive or not consecutive) among the one or more PO candidates. Or, the indicator may indicate specific POs according to a specific pattern.

After the step of S905, the UE may monitor the one or more specific POs among the one or more PO candidates based on the indicator (S907). In the step of S907, if a PO candidate is a specific PO to be used for the UE, the UE may monitor a PDCCH (Physical Downlink Control Channel) signal on the PO candidate. If a PO candidate is not a specific PO to be used for the UE, the UE may not monitor PDCCH on the PO candidate.

When the UE monitors and detects the PDCCH signal for the UE on the specific PO among the one or more PO candidates based on the indicator, the UE may transmit a paging message to the eNB (S909). And then the state of the UE is changed from IDLE mode to RRC_connected mode.

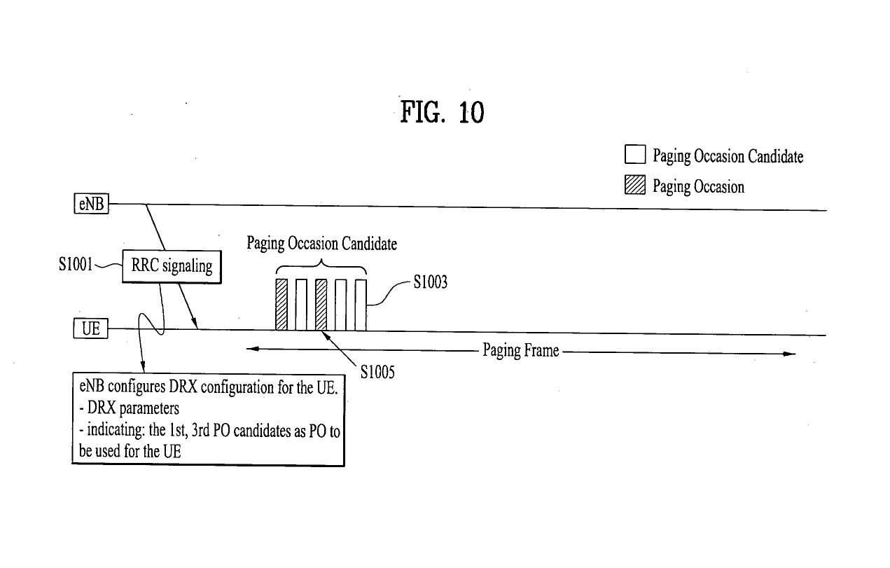

FIG. 10 is a conceptual diagrams an exemplary for monitoring paging occasions according to embodiments of the present invention.

The eNB may transmit RRC signaling including paging information and the indicator. The paging information may include a plurality of DRX parameters used for calculating multiple PO candidates and the indicator may indicate that 1^{st} and 3^{rd} PO candidates are specific POs to be monitored by the UE (S1001).

When the UE calculates multiple PO candidates in the paging frame using the DRX parameter, the UE may recognize that there are 1^{st} to 5^{th} PO candidates in the paging frame (S1003). And the UE may select 1^{st} and 3^{rd} PO candidates in order to monitor a PDCCH signal for the UE (S1005). Since the 1^{st} and the 3^{rd} PO candidates are considered to be specific POs, the UE only monitors the PDCCH signals in the 1^{st} and the 3^{rd} PO candidates.

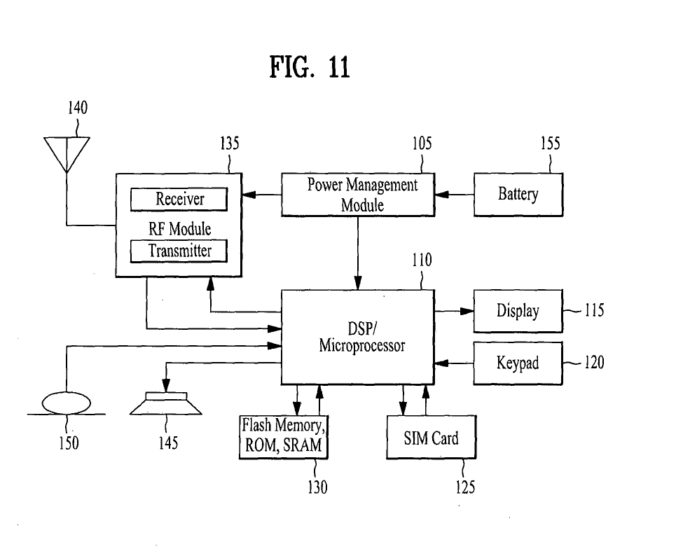

FIG. 11 is a block diagram of a communication apparatus according to an embodiment of the present invention.

The apparatus shown in FIG. 11 can be a user equipment (UE) and/or eNB adapted to perform the above mechanism, but it can be any apparatus for performing the same operation.

As shown in FIG. 11, the apparatus may comprises a DSP/microprocessor (110) and RF module (transceiver; 135). The DSP/microprocessor (110) is electrically connected with the transceiver (135) and controls it. The apparatus may further include power management module (105), battery (155), display (115), keypad (120), SIM card (125), memory device (130), speaker (145) and input device (150), based on its implementation and designer's choice.

Specifically, FIG. 11 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 11 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

1. A method for a user equipment (UE) operating in a wireless communication system, the method comprising:
receiving paging information and an indicator for selecting paging occasions (POs) to be used for the UE;
calculating one or more first POs in a paging frame based on the paging information; and
monitoring one or more second POs among the one or more first POs based on the indicator.

2. The method according to claim 1, wherein the one or more second POs are in the paging frame.

3. The method according to claim 1, wherein said monitoring comprises monitoring one or more Physical Downlink Control Channel (PDCCH) signals for the one or more second POs.

4. The method according to claim 1, wherein the paging information is related to DRX parameters used for deriving the paging frame and the one or more first POs.

5. The method according to claim 1, wherein the paging information and the indicator are received through an RRC signaling.

6. The method according to claim 1, wherein the indicator indicates at least one of:
an n^{th} second PO (where n is positive integer) among the one or more first POs;
1^{st} to n^{th} second POs among the one or more first POs;
nₓ^{th}, n_{y}^{th}, and n_{z}^{th} second POs (where x, y, . . . , z are consecutive) among the one or more first POs;
nₓ^{th}, n_{y}^{th}, and n_{z}^{th} second POs (where x, y, . . . , z are not consecutive) among the one or more first POs; or
one or more second POs among the one or more first POs using a specific pattern.

7. The method according to claim 1, wherein one or more third POs among the one or more first POs are not monitored based on the indicator, wherein the one or more third POs are different from the one or more second POs.

8. A method for a base station (BS) operating in a wireless communication system, the method comprising:
transmitting paging information and an indicator for selecting paging occasions (POs) to be used for a user equipment (UE); and
transmitting one or more Physical Downlink Control Channel (PDCCH) signals for the one or more second POs,
wherein the one or more second POs are selected among one or more first POs in a paging frame based on the indicator.

9. A user equipment (UE) in a wireless communication system, the UE comprising:
an RF (radio frequency) module; and
a processor configured to control the RF module,
wherein the processor is configured to receive paging information and an indicator for selecting paging occasions (POs) to be used for the UE, and to calculate one or more first POs in a paging frame based on the paging information, and to monitor one or more second POs among the one or more first POs based on the indicator.

10. The UE according to claim 9, wherein the one or more second POs are in the paging frame.

11. The UE according to claim 9, wherein the processor is configured to monitor one or more Physical Downlink Control Channel (PDCCH) signals for the one or more second POs when the processor is configured to monitor the one or more second POs.

12. The UE according to claim 9, wherein the paging information is related to DRX parameters used for deriving the paging frame and the one or more first POs.

13. The UE according to claim 9, wherein the processor receives the paging information and the indicator through an RRC signaling.

14. The UE according to claim 9, wherein the indicator indicates at least one of:
an n^{th} second PO (where n is positive integer) among the one or more first POs;
1^{st} to n^{th} second POs among the one or more first POs;
nₓ^{th}, n_{y}^{th}, and n_{z}^{th} second POs (where x, y, . . . , z are consecutive) among the one or more first POs;
nₓ^{th}, n_{y}^{th}, and n_{z}^{th} second POs (where x, y, . . . , z are not consecutive) among the one or more first POs; or
one or more second POs among the one or more first POs using a specific pattern.

15. The UE according to claim 9, wherein the processor is configured not to monitor one or more third POs among the one or more first POs based on the indicator, wherein the one or more third POs are different from the one or more second POs.
